(19) United States
(12) Patent Application Publication
(10) Pub. No.: US 2006/0228550 A1
(43) Pub. Date: Oct. 12, 2006

(54) Method for depositing metallic nanoparticles on monodipersive polystyrene microspheres

(75) Inventors: Jinn-Luh Ou, Sansia Township (TW); Ming-Der Ger, Dasi Township (TW); Yuh Sung, Jhongli City (TW); Hui Chen, Taipei City (TW); Wang-Do May, Jhonghe City (TW); Chun-Chieh Tseng, Fongshan City (TW); Hung-Wen Ling, Nantou City (TW)

Correspondence Address: BACON & THOMAS, PLLC, 625 SLATERS LANE, FOURTH FLOOR, ALEXANDRIA, VA, 22314, US

(73) Assignee: Chung Cheng Institute of Technology, National Defense University, Daxi Town (TW)

(21) Appl. No.: 11/186,872

(22) Filed: Jul. 22, 2005

(30) Foreign Application Priority Data
Apr. 8, 2005 (TW) 094111264

(51) Int. Cl. B32B 5/16

(52) U.S. Cl. 428/402; 524/423; 524/403

(57) ABSTRACT

A method for synthesizing monodipersive polymeric microspheres is disclosed. The method can control the diameter distribution of the microspheres and make it homogeneous. The manufactured polymeric microspheres also have plural functional groups on the surface for depositing metal particles thereon through redox. Moreover, the metal particles can be distributed on the surface of the polymeric microspheres homogeneously.

### BACKGROUND OF THE INVENTION

1. Field of the Invention

The present invention is related to monodispered microspheres and one method for depositing metal particles on the surface of the monodispered microspheres; more particularly, to monodispered polystyrene and the method for depositing metallic nanoparticles on the surface of the monodispered polystyrene particles.

2. Description of Related Art

The application of depositing metallic nanoparticles on the macromolecule particle is broad. For example, the deposition of metallic nanoparticles on the particles can be used in medical or biochemical fields, or used as excellent physical simulation materials. In the past time, the synthysized polymeric nanoparticles or the deposition of metallic nanopracticles is achieved by the polymerization of polyglutaraldehyde microspheres. Through the polymerization illustrated above, crosslinked polymeric particles with the particle size ranging from 20 nm to 10 μm are produced in the existence of the surfactant isobutoxy acrylamide. Moreover, polyglutaraldehyde particles react with antibodies to produce Immunopolyglutaraldehyde microspheres that can be used in labeling and segregating human cells. The said method, however, requires controlled conditions that are inconvenient to mass production. Also, in the U.S. Pat. No. 4,624,923, Margel discloses a method for coupling transition metals (Au, Ag, Pt, Pd, Tc, Fe, Ni or Co) to polyaldehyde microsphere, and part of the transition metallic ions can be reduced to their element state directly. The majority of the transition metallic ions, however, require appropriate reducing agent and sufficient time to be reduced on the polyaldehyde particles. The particles carrying metal are generally used in medical diagnosis, catalysts and coating dispersion. Since the method requires long time for the reducing reaction and complicated processes without the use of reducing agent, it is not practical in the mass-production.

In another method for manufacturing encapsulating macromolecule particles, appropriate reducing agent are required to added during the reaction to reduce the precursor to produce metallic nanoparticles. Or different monomers are added when macromolecule particles are copolymerized. The different functional group of the added monomer reacts with inorganic metallic reaction in the surface. The manufacturing can also be achieved through the method of utilizing electrostatic precipitation. The metallic particles can be absorbed on the macromolecule particles through electrostatic precipitation. The carrier particle used in the method illustrated above can be PMMA particles, SiO₂ particles or PS particles. If the SiO₂ particles are used as the carrier, then organic acid is utilized to make the SiO₂ particles coupled with functional groups. A stabilizer is added to control the size of particle diameter of the metallic particles, and to stabilize the particles not to aggregate. Moreover, the functional group of the stabilizer will react with the carrier particles, and bond on its surface. On the other hand, if PMMA particles are used as the carrier , then the reaction temperature will be about 120 to 140° C. to proceed a reaction of PMMA particles and inorganic metallic particles.

### SUMMARY OF THE INVENTION

The present invention discloses one method for directly depositing metallic nanoparticles on the surface of monodispersive polystyrene microsphers. The method utilizes emulsifier-free emulsion polymerization; thus it is not required to add surfactant nor change the pH value to produce particles with unifying diameters that ranges from 15 nm to 1000 nm and comprises excellent dispersion. Moreover, it further changes the monomer solid content and controls the diameter of the polymeric particles. The polar solvent is added under the identical solid content to increase the solubility of the monomer in the system, making number of nucleation increase in the polymeric system and greatly decreases the diameters of polymeric particles.

The present invention uses polystyrene particles having functional group such as —OSO₃⁻ on the surface of the polystyrene microspheres to react with metallic ions. Hence, it is not necessary to link to external functional groups and adding additional reducing agent. The metal can be precipitated without complicated reactions.

The polystyrene particles for reducing metals in the present invention have a chemical structure as shown in formula (I): 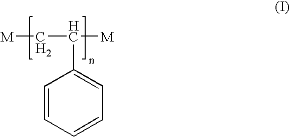
wherein n is an integer greater than 1, and M is —OSO3- or a metal. When M is a metal, it can be the functional compound nanoparticles for precipitating metals on the surface.

The method for manufacturing nanoparticles on polystyrene microspheres, comprising the steps of (A) forming a mixture by mixing potassium persulfate with styrene monomer, wherein the concentration of said potassium persulfate is between 0.1×10⁻³ M to 10×⁻³ M; (B) heating the mixture to initiate polymerization; (C) filtrating the reacted mixture to obtain polymerized polystyrene particles; wherein the polystyrene particles have an average diameter between 15 nm and 1000 nm; and (D) mixing the polymerized polystyrene particles with a solution containing metallic ions, and further filtrating after heating.

The metal in the present invention can be any conventional metals, preferably gold, silver, palladium, platinum, or ruthenium (Ru). The average diameter of the polystyrene particles for reducing metals in the present invention is preferably below 900 nm, and of the best to be between 15 nm to 270 nm. The polystyrene particles for reducing metals in the present invention can be formed by any conventional method, but preferably by polymerization of styrene monomer and potassium persulfate. Also, polar solvent may be selectively added in Step (A) to control the diameter of the polystyrene particles.

The present invention discloses PS particles with monodispersive diameter manufactured by emulsifier-free emulsion. Due to the particles themselves comprise sulfate functional groups, the system can deposit metallic nanoparticles without additional reducing agent, and by chemical oxidation only. The said nanoparticles made through the method of the present invention can be applied in coating, adhesives, biochemical materials, catalyst carriers and filler for columns of chromatography. It is able to synthesize or produce polystyrene particles with monodispersive diameters by emulsifier-free emulsion, wherein the synthesized particle diameter ranges from 15 nm to 270 nm. Not only the synthesized particles have monodispersive diameter, but they also comprise excellent dispersion.

During the process of depositing metals, it is not necessary to add reducing agents. Moreover, during the process of reducing the metals, the time, temperature or the concentration of the system parameters can be adjusted or changed to control the size of the diameter of the deposited metallic particles.

One example of the method of the present invention can be achieved by dissolving potassium persulfate in deionized water, taking certain amount of the solution to the container and in accordance the amount of the necessary styrene monomer. The solution is heated to 70° C. and allow it to react about 6 to 24 hours. When the reaction is complete, filtrate to obtain polystyrene particles with monodispersive diameter. The heating method is not limited to oil bathing; all conventional heating method can be applied.

During depositing the metallic particles from the polystyrene particles, no additional reducing agent is necessary. With the unique sulfate functional groups, the polystyrene particle requires no complicated reaction steps to deposit metals.

### BRIEF DESCRIPTION OF THE DRAWINGS

FIG. 1 is the particle diagram of one preferred embodiment of the present invention.

FIG. 2 is the X-ray diffractometer result of one preferred embodiment of the present invention.

### DETAILED DESCRIPTION OF THE PREFERRED EMBODIMENT

### Embodiment 1 The Compound of Polystyrene Particles

Take potassium persulfate (with concentration 3×10 ⁻³ M) and dissolve it in de-ionized water for ten minutes. Take certain amount of the mixture to mix with required amount of styrene monomer (6 ml). Heat up the mixture to 70° C. and continue the reaction for 24 hours. When time is up, cool and filtrate the solution, wash and purify by water, then polystyrene particles with unifying diameter can be obtained.

### Embodiment 2 to 11

The synthesized steps are the same as preferred embodiment 1, except that the styrene monomer is adjusted in accordance with the amount listed in table 1-1. Also, after the polystyrene particles are synthesized, the average diameter from the testing result is shown in table 1-2. As shown in table 1-2, the average diameter for example 2 (no additional acetone solvent added) is 508 nm wherein example 3 (acetone solvent added) the average diameter is 203 nm. Therefore, during the process of compounding in the present invention, additional polar solvent (acetone in the preferred embodiment) will effectively reduce the average diameter of the polystyrene particles. Please refer to preferred embodiment 9 and 10 for the similar result.

TABLE 1-1

| | Example | | | | | | | | | |
|---|---|---|---|---|---|---|---|---|---|---|
| | 2 | 3 | 4 | 5 | 6 | 7 | 8 | 9 | 10 | 11 |
| Styrene monomer | 6.0 | 6.0 | 3.0 | 2.0 | 1.0 | 0.75 | 0.5 | 0.2 | 0.2 | 0.05 |
| (ml) | | | | | | | | | | |

| | |
|---|---|
| Potassium | 3 × 10⁻³ M |

persulfate (KPS)

TABLE 1-2

| Monomer | | | | |
|---|---|---|---|---|
| (Styrene) | | | | |
| Monomer | Solid | | Acetone | Average |
| Content | Content | Initiator | Solvent | Diameter |
| (×10⁻¹ ml) | (%) | (KPS) | (Vol %) | (nm) |
| 60 | 10.0 | 3 × 10⁻³ M | — | 508 |
| 60 | 10.0 | | 40 | 203 |
| 30 | 5.3 | | — | 463 |
| 20 | 3.6 | | — | 363 |
| 10 | 1.8 | | — | 241 |
| 7.5 | 1.4 | | — | 212 |
| 5.0 | 0.9 | | — | 182 |
| 2.0 | 0.4 | | — | 88 |
| 2.0 | 0.4 | | 20 | 60 |
| 0.5 | 0.04 | | — | 20 |

### Embodiment 12 to 16: Precipitating Metallic particles from the Polystyrene Particles

Take certain amount of embodiment 2 of PS particles (0.5 g, 508 nm) to add to 100 ml deionized water and heat the solution. When it reaches the necessary temperature, add noble metal solution (as shown in table 2). The solution is then filtrated, washed, and then dried to obtain functional complex nanoparticles. The operation temperature are 95° C. and reacting time of 1 minute.

TABLE 2

| Example | Metallic Solution | Concentration |
|---|---|---|
| 12 | PdCl₂ | 800 (ppm) |
| 13 | AgNO₃ | 10000 (ppm) |
| 14 | HAuCl₄ | 10000 (ppm) |
| 15 | H₂PtCl₆ | 10000 (ppm) |
| 16 | RuCl₃ | 10000 (ppm) |

During the process of depositing metallic particles from the polystyrene particles in the above compounding steps of complex particles, it is not necessary to add reducing agent to reduce the metal on the particles. The unique sulfate function group on the particles makes it deposit metals without complicated reactions.

### Embodiment 17

Take a certain amount of PdCl₂ (800 ppm) and PS particle suspension (0.5 g/100 ml,508 nm), follow the same steps as listed in preferred embodiment 12 with heating temperature and reacting time as shown in table 3. Moreover, the de-ionized water can be 54 ml. The higher the temperature, the bigger the reduced Pd atoms; and the longer the reacting time,the bigger the reduced Pd atoms.

TABLE 3

| | Temperature (° C.) | | | | | | | | |
|---|---|---|---|---|---|---|---|---|---|
| | 70 | 70 | 70 | 80 | 80 | 80 | 90 | 90 | 90 |
| | Time (min) | | | | | | | | |
| | 1 | 5 | 10 | 1 | 5 | 10 | 1 | 5 | 10 |
| Diameter of Pd | 5.84 | 6.42 | 7.50 | 8.22 | 8.30 | 8.71 | 8.33 | 9.18 | 9.78 |
| nanoparticles (nm) | | | | | | | | | |

### Embodiment 18

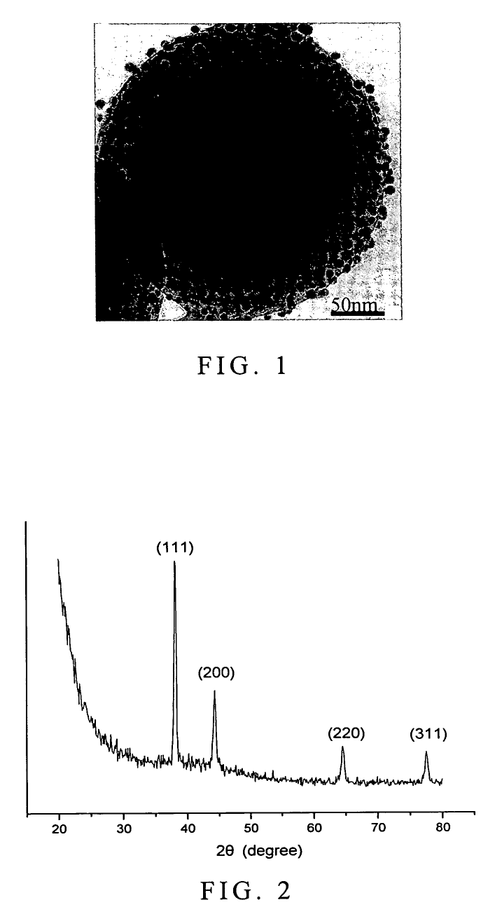

In this preferred embodiment, all the steps are the identical to the preferred embodiment 17 except the PdCl₂ is replaced by AgNO₃. As shown in FIG. 1. The higher the temperature, the bigger the reduced Ag clusters; and the longer the reacting time, the bigger the reduced Ag clusters.

### Embodiment 19

In this preferred embodiment, all the steps are identical to those of the preferred embodiment 17 except the PdCl₂ is replaced by HAuCl₄. For the Au metallic ion, the higher the temperature, the bigger the reduced Au atoms; and the longer the reacting time, the bigger the reduced Au atoms. FIG. 2 is the X-ray diffractometer testing result of Au nanoparticles deposited from polystyrene particles. The figure shows demonstrates that the surface of the polystyrene particles of the present invention indeed deposits gold nanoparticles so FIG. 2 shows gold comprising different crystallines.

### Embodiment 20

In this preferred embodiment, all the steps are the identical to the preferred embodiment 17 except the PdCl₂ being replaced by H₂PtCl₆. For the Pt metallic ion, the higher the temperature, the bigger the reduced Pt atoms; and the longer the reacting time, the bigger the reduced Pt atoms.

### Embodiment 21

In this preferred embodiment, all the steps are the identical to the preferred embodiment 17 except the PdCl₂ being replaced by RuCl₃. For the Ru metallic ion, the higher the temperature, the bigger the reduced Ru atoms; and the longer the reacting time, the bigger the reduced Ru atoms.

The polymerization of the present invention not only can control the diameter size via the monomer content, but also the diameter is unified and the control of diameter can be up to as small as 20 nm. Adding acetone solvent in the system can further reduce the polymeric particle size and obtain particles with unifying diameter. Marco-molecular particles manufactured by emulsifier-free emulsion polymerization have the following properties: (1)there is no existence of emulsifier impurities; thus when it is used in medical or biochemical applications, there will not be any problems in removing the emulsifier impurities; (2) due to the stabilizing particle groups are chemically bonded to the surface of the particles, the purity of the particle is high and chemical properties are stable, which make it an excellent application material in physical simulation research.

Moreover, observing Pd or other metals as the temperature and time change, it is found that the higher the temperature, the bigger the diameter of the Pd or other metallic ions particles. Also, the longer reacting time is used, the bigger diameter of the Pd or other metallic particles is produced.

The present invention discloses one method that utilizes metallic nanoparticles from macromolecule particles by chemical redox without involving reducing agent. The method also requires no surfactant; it can compound unifying polystyrene particles by emulsifier-free emulsion. The compounded particles not only are unifying in diameters, but also have excellent dispersion.

Although the present invention has been explained in relation to its preferred embodiment, it is to be understood that many other possible modifications and variations can be made without departing from the spirit and scope of the invention as hereinafter claimed.

What is claimed is:

1. A method for manufacturing nanoparticles on polystyrene microspheres, comprising the steps of:
(A) forming a mixture by mixing potassium persulfate with styrene monomer, wherein the concentration of said potassium persulfate is between 0.1×10⁻³M to 10×10⁻³M;
(B) heating the mixture to initiate polymerization;
(C) filtrating the reacted mixture to obtain polymerized polystyrene particles; wherein the polystyrene particles have an average diameter between 15 nm and 1000 nm; and
(D) mixing the polymerized polystyrene particles with a solution containing metallic ions, and further filtrating after heating.

2. The method as claimed in claim 1, wherein the said metallic ion is gold, silver, palladium (Pd), platinum (Pt), or ruthenium.

3. The method as claimed in claim 1, wherein the polystyrene particles having a structure of formula (I): 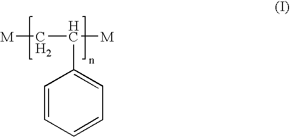
wherein n is an integer greater than 1, and M is —OSO₃— or metal.

4. The method as claimed in claim 4, wherein M is —OSO₃—.

5. The method as claimed in claim 1, wherein the average diameter of the polystyrene particles is between 15 nm and 270 nm.

6. The method as claimed in claim 1, wherein the step (A) the mixture is formed through mixing potassium persulfate, styrene monomer and polar solvent to control the diameters of the polystyrene particles.

7. The method as claimed in claim 2, wherein the method is applied for forming Nano metals on the surface of the polystyrene particles.

8. A method for synthesizing monodipersive polystyrene microspheres, comprising the steps of:
(A) forming a mixture by mixing potassium persulfate with styrene monomer, wherein the concentration of said potassium persulfate is between 0.1×10⁻³M to 10×10⁻³M;
(B) heating the mixture to initiate polymerization; and
(C) filtrating the reacted mixture to obtain polymerized polystyrene particles; wherein the polystyrene particles have an average diameter between 15 nm and 270 nm.

9. A polystyrene particle for reducing metal, and having a structure of formula (I): 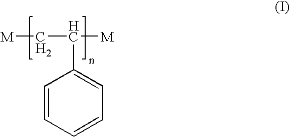
wherein n is an integer greater than 1, and M is —OSO_{3—} or metal.

10. The polystyrene particle as claimed in claim 9, wherein M is gold, silver, palladium (Pd), platinum (Pt), or ruthenium.

11. The polystyrene particle as claimed in claim 9, wherein the particle is made by initiating the polymerization of styrene monomer through potassium persulfate.

12. The polystyrene particle as claimed in claim 9, wherein the average diameter of the polystyrene particle is between 15 nm and 270 nm.
